(19) United States
(12) Patent Application Publication
(10) Pub. No.: US 2004/0125529 A1
(43) Pub. Date: Jul. 1, 2004

(54) Power module

(75) Inventors: Kiyoshi Arai, Tokyo (JP); Nobuhisa Honda, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 10/463,527

(22) Filed: Jun. 18, 2003

(30) Foreign Application Priority Data
Dec. 25, 2002 (JP) 2002-373737

(51) Int. Cl. H02H 9/06

(52) U.S. Cl. 361/118

(57) ABSTRACT

In a power module in which a chip such as a power semiconductor is packaged, it is difficult to provide noise reducing means to a plurality of electrodes (leads) in the module from a viewpoint of a providing space. Therefore, in the power module of the present invention, a plurality of electrodes (8) which connect a chip and connecting terminals are collectively surrounded by a single ferrite core (15), and the ferrite core is embedded in a gel-type silicon (14) for protecting the chip.

### BACKGROUND OF THE INVENTION

1. Field of the Invention

The present invention relates to a power module in which a noise absorber or a noise absorbing material is mounted to a noise generating position in order to reduce an electromagnetic noise radiated at that time of switching of a power semiconductor.

2. Description of the Related Art

In recent years, while EMC regulations are strict, reduction in a radiant noise in various industrial apparatuses including a general-purpose inverter becomes a technical problem. Particularly as for reduction in a radiant noise generated by switching a power semiconductor as a main part of these apparatuses, it is necessary to reduce a noise of a power module itself mounted with a power semiconductor element.

Countermeasures have been taken mainly against a noise in apparatuses such as an inverter, but users are forced to take various countermeasures in order to clear the EMC regulations. The countermeasures on a power module side are as follows.

A bead core is inserted into one end of a diode composing a switching power source (for example, see Document 1).

In addition, in a semiconductor device for large power, an entire power portion in a case is covered with a magnetic field impermeable member (for example, see Document 2).

Further, in a semiconductor device, ferrite powder is dispersed in epoxy resin as a mold resin (for example, see Document 3). Moreover, an electromagnetic absorbing material includes composite magnetic particles in which magnetic metal particles and ceramic are integral with each other (for example, see Document 4).

In addition, in a high-frequency circuit module for a general-purpose inverter, a space in a frame is filled with ferrite compound resin (for example, see Document 5).

In a semiconductor device having a structure in which mounted parts and a wiring substrate are sealed by mold resin such as epoxy resin, ferrite powder is dispersed in and added to a sealer (for example, see Document 6).

Document 1

Japanese Patent Application Laid-Open Publication No. 8-279592 (1996) “ASSEMBLY STRUCTURE OF SWITCHING POWER SOURCE RECTIFIER” (Paragraph No. [0014], FIG. 3).

Document 2

Japanese Patent Application Laid-Open Publication No. 8-293578 (1996) “SEMICONDUCTOR DEVICE” (Paragraph No. [0030], FIG. 3).

Document 3

Japanese Patent Application Laid-Open Publication No. 11-040708 (1999) “SEMICONDUCTOR DEVICE” (Paragraph No [0025], FIG. 2).

Document 4

Japanese Patent Application Laid-Open Publication No. 2001-358493“ELECTROMAGNETIC-WAVE ABSORBER” (Paragraph No. [0022], FIG. 14).

Document 5

Japanese Patent Application Laid-Open Publication No. 5-291783 (1993) “HIGH-FREQUENCY CIRCUIT MODULE” (Paragraph No. [0007], FIG. 1).

Document 6

Japanese Patent Application Laid-Open Publication No. 11-214592 (1999) “SEMICONDUCTOR DEVICE” (Paragraph No. [0048], FIG. 1).

However, like Document 2, in a method of covering the entire power portion with the magnetic field impermeable member, it is difficult to cover dispersed electrode (lead).

In Document 3, the ferrite powder is dispersed in the epoxy resin as mold resin of the semiconductor device, but a transfer mold type in which mold resin directly comes in contact with the power semiconductor element requires low-stress type resin with less impurity, and the ferrite powder cannot be mixed with the resin.

Document 4 provides the electromagnetic absorber including the composite magnetic particles in which the magnetic metal particles and ceramic are integral with each other, but in like a power module in which its inside is filled with resin or the like for reinforcement, it is difficult to additionally provide a radio-wave absorber.

In addition, in Documents 5 and 6, although the space in the case is filled with the ferrite compound resin, when the resin which comes in contact with a chip surface includes ferrite powder, an insulating performance is deteriorated.

### SUMMARY OF THE INVENTION

The present invention provides a power module which is capable of solving the above problems.

A ferrite material is classified into hard ferrite and soft ferrite. The hard ferrite is use mainly for permanent magnet, and the soft ferrite is widely used as a noise absorber to be used for EMC countermeasures.

A magnetic field is generated around a cable and an electrode in which an electric current flows, and this magnetic field is discharged as a radio wave to the outside through the cable and the electrode as an antenna. When a passage in which the electric current flows is inserted through a ring-shaped core made of ferrite (hereinafter referred to as a ferrite core), the magnetic field generated around the passage is concentrated into the ferrite core, and the magnetic field is converted into heat in the ferrite core so that strength of the radio wave radiated to the outside is reduced.

According to the present invention, in the power module, a plurality of electrodes which connect an internal chip and connecting terminals are collectively surrounded by a single noise absorber, and the noise absorber is embedded in a gel-type sealer for protecting chip.

### BRIEF DESCRIPTION OF THE DRAWINGS

FIG. 1 is a cross sectional view of a power module according to a first embodiment of the present invention;

FIG. 2 is a circuit diagram of the power module in FIG. 1;

FIG. 3 is a cross sectional view of the power module according to a second embodiment of the present invention;

FIG. 4 is a side sectional view of the power module according to a third embodiment of the present invention;

FIG. 5 is a cross sectional view of the power module according to a fourth embodiment of the present invention;

FIG. 6 is a cross sectional view of the power module according to a fifth embodiment of the present invention;

FIG. 7 is a cross sectional view of the power module according to a sixth embodiment of the present invention;

FIG. 8 is a cross sectional view of the power module having a transfer mold structure according to a seventh embodiment of the present invention; and

FIG. 9 is a cross sectional view of the power module according to an eighth embodiment of the present invention.

### DETAILED DESCRIPTION OF THE PREFERRED EMBODIMENTS

First Embodiment

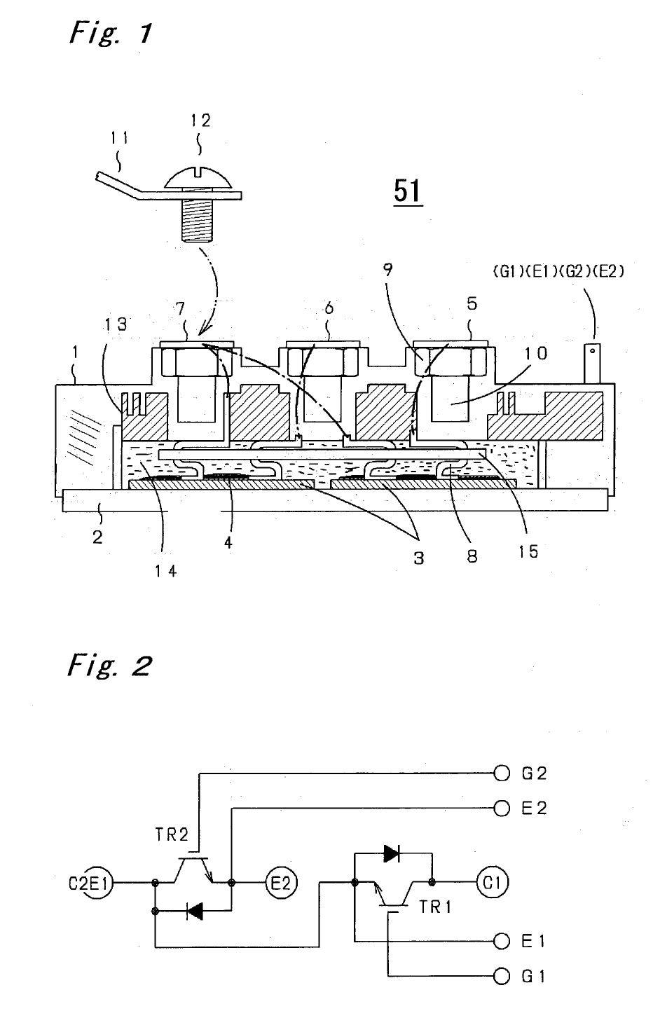

FIG. 1 is a cross sectional view of a power module 51 according to a first embodiment of the present invention (corresponding to claim 1). As shown in FIG. 2, this power module has a monophasic power module structure (this is applied to the following embodiments), and elements common in both the diagrams are designated by common reference numerals.

A ceramic substrate 3 is positioned on a copper base plate 2 which is a bottom plate of a case 1 made of plastic, and a silicon chip 4 such as a transistor or a diode is mounted onto the ceramic substrate 3.

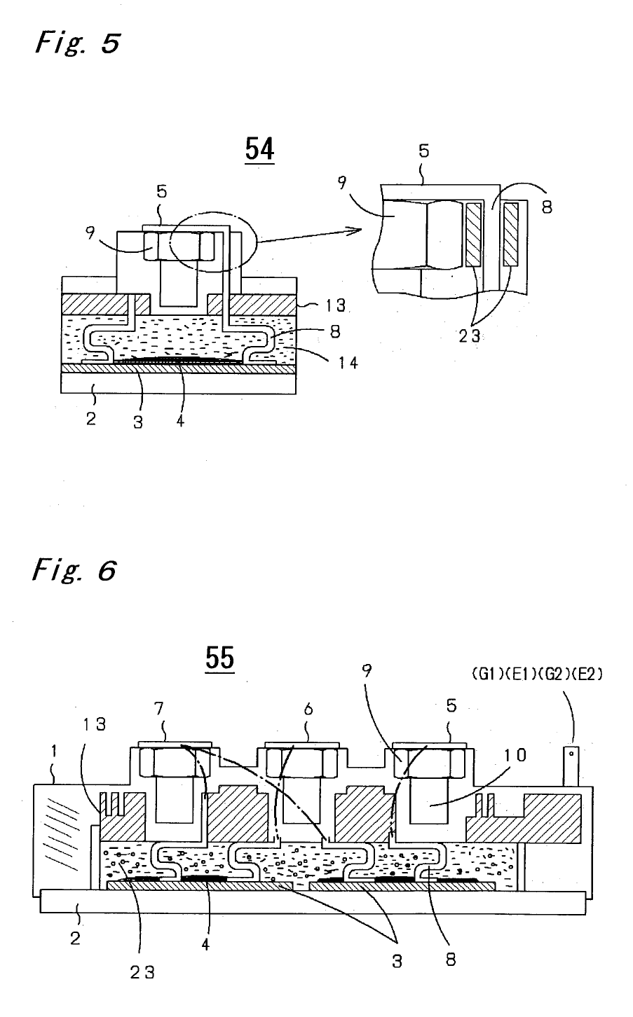

An upper portion of the case 1 is provided with a collector terminal (C1) 5 of a transistor TR1, an emitter terminal (E2) 6 of a transistor TR2, and a common terminal (C2E1) 7 for an emitter (E1) of the transistor TR1 and a collector (C2) of the transistor TR2. These terminals 5 through 7 are connected to the silicon chip 4 through electrodes 8 (the connection between the terminals and the electrodes 8 is shown in FIG. 5 which is referred to later). Moreover, terminals for an emitter electrode (E1) and a gate electrode (G1) of the transistor TR1, and an emitter electrode (E2) and a gate electrode (G2) of the transistor TR2 are provided.

In addition, nuts 9 are embedded respectively below the terminals 5 through 7 in the case 1, and concave holes 10 are formed under the nuts 9, respectively. A lead 11 is put into the nuts 9 and a screw 12 is tightened, so that the terminals 5 through 7 are electrically connected with the leads 11. Epoxy resin 13 provided to sides of the concave holes 10 is used for increasing strength of the case 1.

An upper surface of the silicon chip 4 and peripheries of the four electrodes 8 drawn out of the silicon chip 4 are filled with gel-type silicon 14 as a gel-type sealer, but in the present first embodiment, the four electrodes 8 penetrate through a ferrite core 15 which is provided in the gel-type silicon 14 as a noise absorber. The ferrite core 15 forms an oval ring.

In the power module in FIG. 1, when the ferrite core 15 is provided so as to surround all the internal electrodes, radiation of a noise generated at the time of a switching operation of the power semiconductor can be prevented by the one ferrite core 15. In the case where the electrodes 8 adjoin each other, miniaturization can be achieved.

Second Embodiment

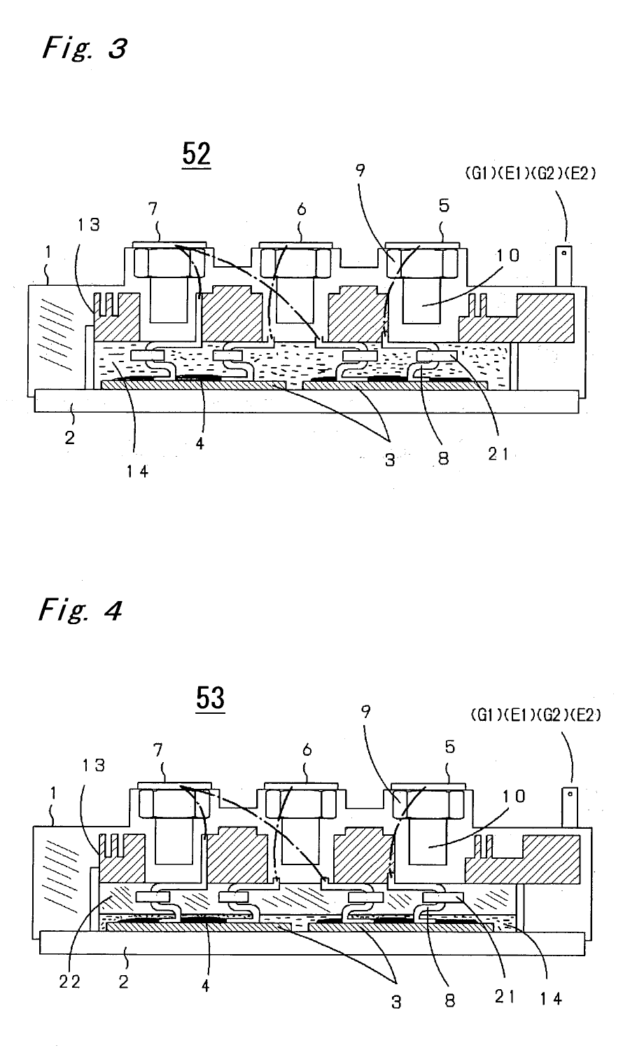

FIG. 3 is a cross sectional view of the power module 52 according to a second embodiment of the present invention (corresponding to claim 2), and the same elements as those in FIG. 1 are designated by common reference numerals. In the second embodiment, ferrite cores 21 are provided individually to the four electrodes 8, and the respective ferrite cores 21 are embedded into the gel-type silicon 14. The ferrite cores 21 having a ring shape are generally used. A position which is surrounded by the ferrite cores 21 is not particularly limited as long as they are inserted into the gel-type silicon 14. Moreover, the ferrite cores 21 are embedded completely into the gel-type silicon 14 because when the ferrite cores 21 are partially covered with epoxy resin, a mechanical stress exerts thereon and thus there is a possibility that the ferrite cores 21 are damaged.

According to the power module in FIG. 3, the noise which is generated at the time of the switching operation of the power semiconductor is prevented by the ferrite cores 21 corresponding to the respective electrodes from being radiated via the electrodes, so that a noise reducing effect can be obtained in the power module. Particularly in the case where distances between the electrodes 8 are long or structures of the electrodes 8 differ, the ferrite cores 21 can be provided individually, so that saving space can be achieved in the entire power module.

Third Embodiment

FIG. 4 is a cross sectional view of the power module 53 according to a third embodiment of the present invention (corresponding to claim 3). A different point from FIG. 3 is that the gel-type silicon 14 covers only the silicon chip 4, and the four ferrite cores 21 are embedded in thermoset epoxy resin 22 positioned as a sealer on the gel-type silicon 14, and the ferrite cores are in noncontact with the other parts.

In the first and second embodiments, the ferrite cores 15 and 21 are embedded in the elastic gel-type silicon 14, but the ferrite corers are not completely fixed due to this elasticity. Since any fixing means such as providing a notch or the like for locating the ferrite core on the electrodes 8 is normally taken, their position is scantly fixed, but there is a possibility that the mounting position shifts under a certain condition in the case where oscillation or the like is added. Particularly in the case where the ferrite cores adjoin the other parts, there is a possibility of a damage due to contact.

However, according to the power module in FIG. 4, since the ferrite cores 21 are embedded in the epoxy resin 22, the ferrite cores 21 do not move even under a certain condition in the case where oscillation or the like is added, thereby preventing the damage or the like due to the contact.

Fourth Embodiment

FIG. 5 is a cross sectional view in which the power module 54 according to a fourth embodiment (corresponding to claim 4) is viewed from a side direction. A ferrite core 23 is inserted into an upper portion of the electrode 8 connected with the collector terminal 5 (side of the nut 9). In FIG. 5, the ferrite cores 23 are arranged on the other terminals 6 and 7, not shown in FIG. 5 similarly.

A noise is generated by switching of the power semiconductor as explained above and is discharged to the outside via a member to be an antenna. In the first through third embodiments, the structure is such that a magnetic field is absorbed in the internal electrodes of the power module, but for example in the case where the power module is used for industrial apparatuses such as an inverter, the external electrodes should be connected by a bus bar or a power board for electric power. At this time, the connected portions are unprotected from the noise. On the contrary, conventionally a countermeasure has been taken on the inverter side.

In the fourth embodiment, since the ferrite cores 23 are provide around mounted portions of the terminals externally connected, a noise reducing effect is obtained on the exposed type electrodes. As a result, the noise generated at the time of the switching operation of the power semiconductor can be prevented from being radiated via the electrodes on a portion connected to an industrial apparatus such as an inverter.

Fifth Embodiment

FIG. 6 is a cross sectional view of the power module 55 according to a fifth embodiment of the present invention (corresponding to claim 5). Like the above first through fourth embodiments, when the electrodes of the power module are surrounded by the ferrite cores, the noise reducing effect is produced. However, since in some product, particularly a small-size power module or the like, a distance between the terminals is normally short and the product itself is very small, it is considered that individual ferrite cores cannot be provided.

The fifth embodiment is effective means for such a case. The fifth embodiment uses gel-type silicon 23 containing a noise absorbing material in which a ferrite material, for example, as a noise absorbing material is pulverize and is mixed with the gel-type silicon 14 uniformly, and upper surfaces and side surfaces of the components therein are surrounded by the silicon 23, so that a generated magnetic field can be absorbed. Although the noise reducing effect is lower than the case where the electrodes are surrounded by the ferrite cores, since such a small-size and small-capacity power module generally has low noise level, the noise can be reduced to a desired level.

Sixth Embodiment

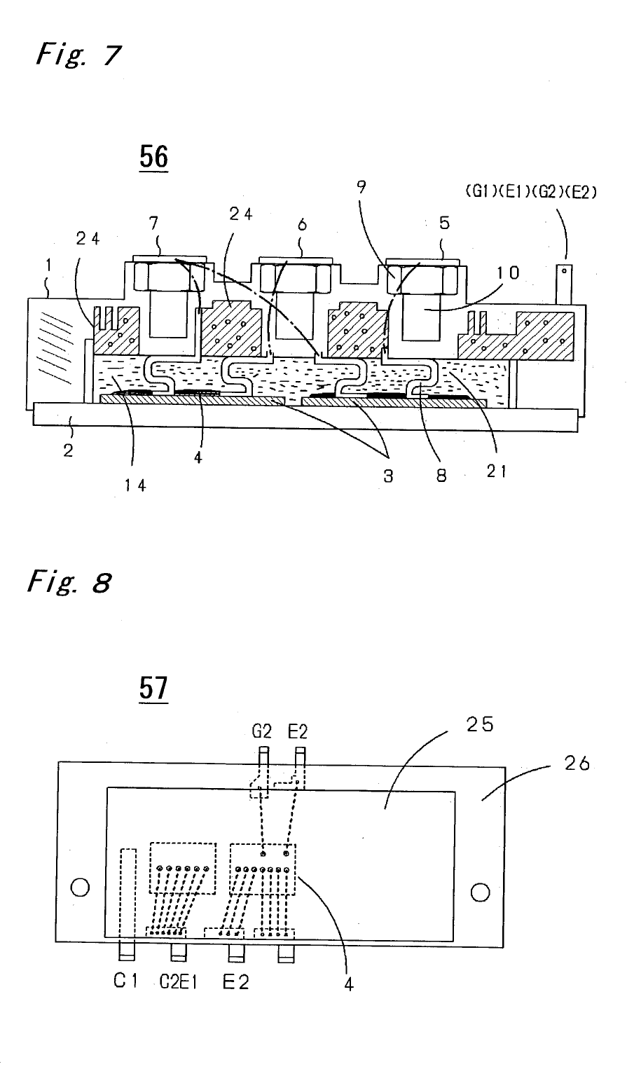

FIG. 7 is a cross sectional view of the power module 56 according to a sixth embodiment of the present invention (corresponding to claim 6). In the fifth embodiment, since the noise absorbing material is mixed with the gel-type silicon, the noise absorbing material which is covered with a thin gel film exists so as to adjoin the chip surface. In this case, an insulating property on the chip surface is lowered, and when a high voltage is applied to the chip, this causes damage of the insulation.

In the sixth embodiment, the surface of the chip 4 is covered with the normal gel-type silicon 14, and the noise absorbing material is mixed with epoxy resin 24 as a sealer to be sealed on the gel-type silicon 14, thereby preventing the insulation in a vicinity of the chip from being lowered. When the sixth embodiment is applied to the case where individual noise absorbing materials cannot be provided in particularly a small-size power module, for example, having high withstand voltage, the noise which is radiated from the chip or a wire at the time of the switching operation of the power semiconductor can be reduced without enlarging its size and without influencing its element characteristics.

Seventh Embodiment

FIG. 8 is a cross sectional view of the power module 57 according to a seventh embodiment of the present invention (corresponding to claim 7). The seventh embodiment shows an application example of the transfer mold structure into the power module. Since in the transfer mold type, mold resin directly comes in contact with a power semiconductor element, low-stress type resin having less impurity has been developed. For this reason, it will be possible in feature that a material is changed by mixing the noise absorbing with this resin, but this is difficult at the current stage.

Therefore, in the seventh embodiment, the silicon chip and the electrodes are covered with a conventional mold material 25, and another resin 26 mixed with the noise absorbing material is additionally molded onto its periphery. As a result, in the transfer mold type power module, when the resin with which the noise absorbing material is mixed is molded onto the outer periphery of the power module without changing the mold resin, the noise which is radiated from the chip, the terminals and the electrodes at the time of the switching operation of the power semiconductor can be reduced without influencing electric characteristic, a mechanical stress and reliability of the chip.

Eighth Embodiment

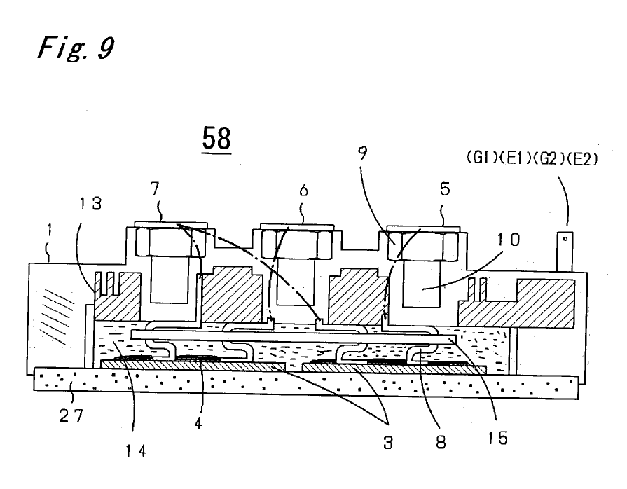

FIG. 9 is a cross sectional view of the power module 58 according to an eighth embodiment of the present invention (corresponding to claim 6). In the power module, as one method of reducing floating inductance, it is utilized that an inductance of a ceramic substrate with a thin copper foil circuit represented by a DBC substrate or the like is smaller than that of the electrode, so that the circuit is occasionally lengthened. In this case, since a circuit pattern becomes an antenna for radiating a noise, it is necessary to take a countermeasure against a noise for this portion.

In the first through seventh embodiments, an attention is paid to that the noise is absorbed from the upper surface side of the power semiconductor element, but in the eighth embodiment the noise absorbing material is mixed with a ceramic substrate 27 to which the silicon chip 4 of the power semiconductor element or the like is attached by solder or the like. As a result, the generated magnetic field is absorbed by the ceramic substrate 27 under the chip, so that the noise to a bottom surface direction generated at the time of the switching operation of the power semiconductor can be reduced.

According to this invention, since all the electrode drawn out of the internal chip are surrounded by the single noise absorber and the noise absorber is embedded in sealing gel for protecting the chip, the magnetic field generated by the switching is efficiently absorbed by the noise absorber, and the generation of the noise to the outside can be suppressed. Moreover, since only one noise absorber may be provided, the module main body does not become large.

What is claimed is:

1. A power module, wherein electrodes drawn out of a chip are surrounded by single noise absorber, and said noise absorbers are embedded in a gel-type sealer for protecting said chip.

2. The power module according to claim 1, wherein said electrodes are surrounded by noise absorbers respectively.

3. The power module according to claim 2, wherein said noise absorbers are embedded in a sealer for sealing a module main body instead of being embedded into the gel-type sealer.

4. The power module according to claim 2, wherein said electrodes are surrounded by said noise absorbers in vicinities of external connecting terminals which are connecting destination of said electrodes.

5. The power module according to claim 1, wherein instead of said noise absorbers, a noise absorbing material is mixed with the gel-type sealer for protecting said chip and said electrodes drawn out of said chip.

6. The power module according to claim 1, wherein said chip is covered with the gel-type sealer and said noise absorbing material is mixed with a sealer provided on the gel-type sealer.

7. A power module of a transfer mold type in which a chip is covered with mold resin, wherein said mold resin is covered with resin containing a noise absorbing material.

8. A power module, wherein a noise absorbing material is mixed with a ceramic substrate mounted with a chip.
